(19) United States
(12) Patent Application Publication
(10) Pub. No.: US 2020/0064161 A1
(43) Pub. Date: Feb. 27, 2020

(54) ENCODER

(71) Applicant: FANUC CORPORATION, Yamanashi (JP)

(72) Inventors: Hirosato Yoshida, Minamitsuru-gun (JP); Nobuyuki Ootake, Minamitsuru-gun (JP)

(73) Assignee: FANUC CORPORATION, Yamanashi (JP)

(21) Appl. No.: 16/545,383

(22) Filed: Aug. 20, 2019

(30) Foreign Application Priority Data
Aug. 24, 2018 (JP) 2018-156917

(51) Int. Cl. G01D 5/245; G01D 5/244; G01D 5/347; G01D 18/00; G01P 3/487

(52) U.S. Cl. CPC G01D 5/2451; G01D 5/24452; G01P 3/487; G01D 18/00; G01D 5/3473

(57) ABSTRACT

An encoder includes: a shaft configured to rotate together with an object to be measured; a rotating member provided on one end side of the shaft and having a pattern formed thereon to detect change of the rotation angle of the shaft; a circuit board arranged to face the rotating member and configured to measure displacement of the rotating member; a magnet configured to rotate together with the shaft; and a power generation element configured to generate electricity by rotation of the magnet. The magnet is arranged so as to pass through a through hole formed in the rotating member; and the power generation element is arranged on a surface of the circuit board that is opposite to a surface thereof facing the rotating member.

### CROSS-REFERENCE TO RELATED APPLICATION

This application is based upon and claims the benefit of priority from Japanese Patent Application No. 2018-156917 filed on Aug. 24, 2018, the contents of which are incorporated herein by reference.

### BACKGROUND OF THE INVENTION

### Field of the Invention

The present invention relates to an encoder for detecting a rotation angle of a shaft.

### Description of the Related Art

Japanese Laid-Open Patent Publication No. 2008-014799 discloses an encoder which has a circuit board and a rotating disk (rotating member) disposed so as to face each other. In this encoder, a power generator is mounted on a surface of the circuit board that is opposite to a surface thereof facing the rotating disk while a permanent magnet is mounted on a surface of the rotating disk that faces the circuit board.

### SUMMARY OF THE INVENTION

In Japanese Laid-Open Patent Publication No. 2008-014799, since a permanent magnet whose thickness cannot be easily reduced is mounted on the surface of the rotating disk facing the circuit board, it is necessary to provide a large distance between the rotating disk and the circuit board, so that a problem occurs in which the encoder cannot be reduced in thickness.

It is therefore an object of the present invention to provide an encoder which can be reduced in thickness.

The present invention resides in an encoder including: a shaft configured to rotate together with an object to be measured; a rotating member provided on one end side of the shaft and having a pattern formed thereon to detect change of the rotation angle of the shaft; a circuit board arranged to face the rotating member and configured to measure displacement of the rotating member; a magnet configured to rotate together with the shaft; and a power generation element configured to generate electricity by rotation of the magnet. The magnet is arranged so as to pass through a through hole formed in the rotating member, and the power generation element is arranged on a surface of the circuit board that is opposite to a surface thereof facing the rotating member.

According to the present invention, it is possible to provide an encoder that can be reduced in thickness.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a vertical section showing a configuration example of an encoder according to an embodiment of the present invention;

FIG. 2 is a diagram for explaining a joint structure in which a rotating member and a magnet are joined to a shaft in the encoder according to the embodiment;

FIG. 3A is a diagram showing a configuration of an encoder of a comparative example 1; FIG. 3B is a diagram showing a configuration of an encoder of a comparative example 2; FIG. 3C is a diagram showing a configuration of an encoder of a comparative example 3;

FIG. 4 is a diagram showing a shaft, a rotating member, a magnet and a nonmagnetic material in an encoder of Modification 2; and

FIG. 5 is a diagram showing a shaft, a rotating member, a magnet and a nonmagnetic material in an encoder of Modification 3.

### DESCRIPTION OF THE PREFERRED EMBODIMENTS

The encoder according to the present invention will be detailed below by describing a preferred embodiment with reference to the accompanying drawings.

### Embodiment

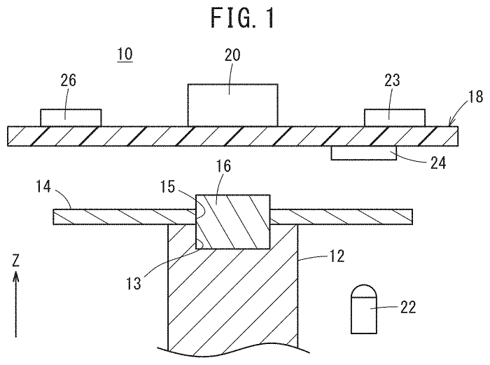

FIG. 1 is a vertical section showing a configuration example of an encoder 10. The encoder 10 is a rotary encoder that optically detects the rotation angle of a shaft 12. Hereinafter, the direction in which the shaft 12 extends will be described as the Z-direction, as illustrated in FIG. 1 and others. The direction indicated by the arrow in the Z-direction shown in FIG. 1 may be referred to as the positive Z-direction, and the direction opposite to the direction indicated by the arrow may be referred to as the negative Z-direction.

As shown in FIG. 1, the encoder 10 includes a shaft 12, a rotating member 14, a magnet 16, a circuit board 18, a power generation element 20, a light emitter 22 and a light receiver 24.

The shaft 12 is rotatably supported by an unillustrated housing via a bearing. The shaft 12 is joined to an object to be measured (which will be also referred to as a measurement target) and rotates together with the measurement object. With this configuration, the encoder 10 can detect the rotation angle of the measurement object. A recess 13 is formed in one endface (the positive Z-direction side) of the shaft 12. Detailedly, the recess 13 is formed at a position that coincides with the rotation axis of the shaft 12, on the endface on the positive Z-direction side of the shaft 12. The center of the recess 13 preferably coincides with the rotation axis of the shaft 12. Herein, the shaft 12 is made of a magnetic material.

The rotating member 14 has, formed thereon, an optical pattern (pattern) for detecting angular displacement (change) of the rotation angle of the shaft 12. The rotating member 14 is arranged on one end side (the positive Z-direction side) of the shaft 12. The rotating member 14 is formed in a circular disk shape. The rotating member 14 is fixed to the shaft 12 coaxially with the shaft 12. The rotating member 14 rotates together with the shaft 12 about the rotation axis of the shaft 12. The rotating member 14 has a through hole 15 formed on the rotation axis of the shaft 12. The center of the through hole 15 is preferably on the rotation axis of the shaft 12. The periphery of the through hole 15 of the rotating member 14 is in contact with the periphery of the recess 13 of the endface of the shaft 12 on the positive Z-direction side.

The optical pattern is a pattern formed on the outer peripheral part of the rotating member 14 to enable detection of the rotation angle of the shaft 12. This optical pattern includes light transmitting areas and opaque areas, which are alternately arranged around the rotation axis of the shaft 12 (around the Z-direction). An example of the light transmitting area includes a slit or the like.

The magnet 16 is a permanent magnet. The magnet 16 is arranged to penetrate the through hole 15. Specifically, the magnet 16 is inserted into the through hole 15 and fitted therein. The magnet 16 is disposed in a position on the rotation axis of the shaft 12. A portion of the magnet 16 that projects from the rotating member 14 toward the shaft 12 (the negative Z-direction side) is accommodated in the recess 13 (detailedly, fitted therein). That is, the magnet 16 is fixed to the shaft 12 in a state of being fitted in the through hole 15 and the recess 13. Thereby, the magnet 16 rotates together with the shaft 12. The end of the magnet 16 on the positive Z-direction side protrudes from the rotating member 14 in the positive Z-direction.

Thus, the magnet 16 is fitted into the recess 13, whereby the magnet 16 is centered on the axis of the shaft 12. Further, the magnet 16 fitted in the recess 13 is fitted into the through hole 15, whereby the rotating member 14 is centered on the axis of and the shaft 12.

Incidentally, the rotating member 14 may be first centered on the axis of the shaft 12, and then the magnet 16 may be fitted into the through hole 15, whereby the magnet 16 may be centered on the axis of the shaft 12. Centering the rotating member 14 on the axis of the shaft 12 first prevents the rotating member 14 from being affected by an error deriving from the gap between the magnet 16 and the recess 13. Accordingly, it is possible to set a large fitting clearance between the magnet 16 and the recess 13, thereby making it easy to assemble. That is, since the magnet 16 is centered on the axis of the shaft 12 by being fitted into the through hole 15, the fitting clearance between the magnet 16 and the recess 13 can be made larger.

The circuit board 18 is disposed so as to face the rotating member 14 and measures displacement of the rotating member 14. The circuit board 18 is disposed on the positive Z-direction side of the rotating member 14 so as to be substantially orthogonal to the Z-direction. The circuit board 18 has, arranged on the positive Z-direction side surface thereof, a signal processor 26 and a driver circuit 23 for driving a light emitter 22 and a light receiver 24.

The light emitter 22 includes a light emitting element such as a light emitting diode, for example. The light emitter 22 is disposed on the negative Z-direction side of the optical pattern formed on the rotating member 14. The light emitter 22 is fixed to an unillustrated housing so as to emit light in the positive Z-direction. The driver circuit 23 causes the light emitting element of the light emitter 22 to emit light constantly during detection of the encoder 10.

The light receiver 24 includes a light receiving element such as a photodiode, for example. The light receiver 24 is disposed on the positive Z-direction side of the optical pattern formed on the rotating member 14. That is, the light emitter 22 and the light receiver 24 are disposed to sandwich the optical pattern of the rotating member 14. The light receiver 24 is provided on the negative Z-direction side surface of the circuit board 18.

The light receiver 24 receives light emitted from the light emitter 22 and having passed through the optical pattern. The light receiver 24 outputs signals obtained by the light reception, to the signal processor 26.

The signal processor 26 detects the rotation angle of the shaft 12 based on the signals from the light receiver 24.

The power generation element 20 is provided on the positive Z-direction side surface of the circuit board 18 and aligned to the rotation axis of the shaft 12. The power generation element 20 is disposed in a position inside the magnetic field generated by the magnet 16. The power generation element 20 has a coil and generates electricity as the magnet 16 rotates. As the distance between the power generation element 20 and the magnet 16 is smaller, the density of magnetic flux passing through the coil of the power generation element 20 is greater, so that the electric power generated by the power generation element 20 becomes greater. When the main power supply for supplying power to the encoder 10 is off, the power generation element 20 generates power even if the measurement object and hence the shaft 12 rotate. Therefore, the signal processor 26 and the driver circuit 23 can be driven using the power generated by the power generation element 20. Thus, the encoder 10 can detect the rotation angle of the shaft 12 even when the main power is off.

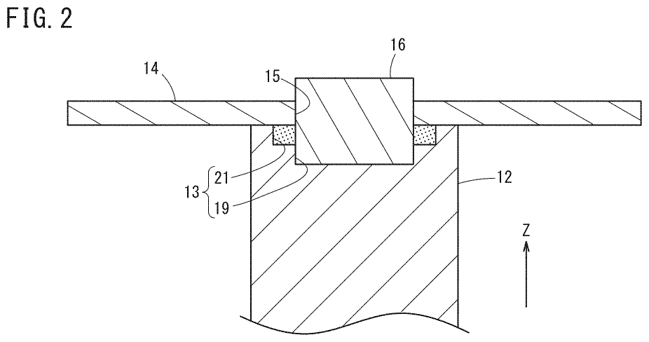

Referring now to FIG. 2, the joint structure of the magnet 16 and the rotating member 14 with the shaft 12 will be described in detail. The recess 13 has a reference hole 19 for positioning the magnet 16 and an adhesive reservoir 21 having a greater diameter than the reference hole 19, formed on the opening side. The adhesive reservoir 21 stores (retains) an adhesive therein. The diameter of the adhesive reservoir 21 is greater than the diameter of the through hole 15. The magnet 16, the rotating member 14 and the shaft 12 are bonded to each other by the adhesive stored in the adhesive reservoir 21.

An example of joining procedures will be briefly described. First, the magnet 16 is inserted (fitted) into the reference hole 19. Then, the adhesive reservoir 21 is injected (filled) with the adhesive. At this time, the adhesive inside the adhesive reservoir 21 contacts the outer periphery of the magnet 16. Finally, the part of the magnet 16 protruding from the adhesive reservoir 21 to the circuit board 18 side (positive Z-direction side) is inserted into the through hole 15 so as to abut the periphery of the through hole 15 of the rotating member 14 against the endface of the shaft 12 on the positive Z-direction side. At this time, the adhesive in the adhesive reservoir 21 contacts the periphery of the through hole 15 of the rotating member 14. Thus, the magnet 16 and the rotating member 14 are joined to the shaft 12.

Another example of joining procedures will be described. First, the periphery of the through hole 15 of the rotating member 14 is abutted against the end surface of the shaft 12 on the positive Z-direction side so that the center of the rotating member 14 coincides with the center of the shaft 12. Next, the magnet 16 is inserted into the through hole 15 and the reference hole 19. Finally, the adhesive is injected into the adhesive reservoir 21. At this time, the adhesive in the adhesive reservoir 21 contacts the periphery of the through hole 15 of the rotating member 14 and the outer periphery of the magnet 16. Thus, the magnet 16 and the rotating member 14 are joined to the shaft 12. Here, the adhesive may be injected through, for example, the gap between the through hole 15 and the magnet 16, or may be injected through a channel which is formed in the shaft 12 for adhesive injection.

Next, the encoder configurations of comparative examples (conventional examples) and their problems will be described below.

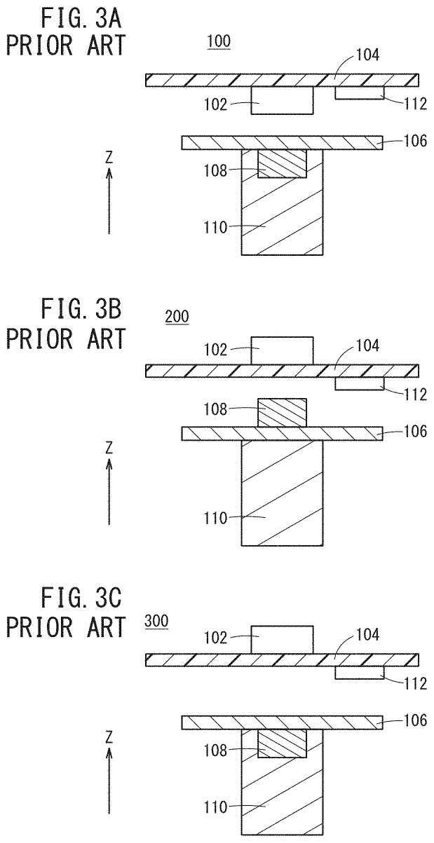

In an encoder 100 of a comparative example 1 shown in FIG. 3A, a power generation element 102 is arranged on the negative Z-direction side surface of a circuit board 104 while a magnet 108 is embedded in a shaft 110. Since it is difficult to make the power generation element 102 thinner, it is necessary in comparative example 1 to set a large distance between the circuit board 104 and a rotating member 106, and hence the encoder 100 results in being thick. When the distance between the circuit board 104 and the rotating member 106 is increased, the spread angle of light having passed through the optical pattern on the rotating member 106 becomes large, and accordingly a large-sized light receiving element 112 is needed. In the comparative example 1, since the magnet 108 is buried in the shaft 110 made of a magnetic material, the influence of the shaft 110 on the magnetic field generated by the magnet 108 is increased.

In an encoder 200 of a comparative example 2 shown in FIG. 3B, a magnet 108 is arranged on the positive Z-direction side surface of a rotating member 106 while a power generation element 102 is provided on the positive Z-direction side surface of a circuit board 104. Since the magnet 108 needs to generate a magnetic field necessary for detection, it is difficult to reduce the thickness. Therefore, it is necessary in comparative example 2 to set a large distance between the circuit board 104 and the rotating member 106, and hence the encoder 200 results in being thick. When the distance between the circuit board 104 and the rotating member 106 is large, the spread angle of light having passed through the optical pattern formed on the rotating member 106 becomes large, and accordingly a large-sized light receiving element 112 is needed.

In an encoder 300 of a comparative example 3 shown in FIG. 3C, a power generation element 102 is provided on the positive Z-direction side surface of the circuit board 104 while a magnet 108 is embedded in a shaft 110. In the comparative example 3, since there is a long distance between the power generation element 102 and the magnet 108, the power generated by the power generation element 102 is reduced. In order to suppress the reduction, the magnet 108 needs to be enlarged. Further, in the comparative example 3, since the magnet 108 is buried in the shaft 110 made of a magnetic material, the influence of the shaft 110 on the magnetic field generated by the magnet 108 is increased.

In the present embodiment, the power generation element 20 is disposed on the positive Z-direction side surface of the circuit board 18, and the magnet 16 is inserted in the through hole 15 of the rotating member 14. With this configuration, the distance between the circuit board 18 and the rotating member 14 can be reduced while the influence of the shaft 12 on the magnetic field generated by the magnet 16 is suppressed. That is, the encoder 10 can be reduced in thickness while reducing the influence of the shaft 12 on the magnetic field generated by the magnet 16.

### MODIFICATIONS

The configuration of the encoder 10 described in the above embodiment can be changed as appropriate.

### Modification 1

In the above embodiment, the magnet 16 is fitted into the through hole 15, but may not be tightly fitted. The point is that the through hole 15 is formed so as to allow the magnet 16 to pass therethrough. That is, the diameter of the through hole 15 may be made greater than that of the magnet 16. When the magnet 16 is not tightly fitted into the through hole 15, the magnet 16 and the rotating member 14 are placed on the shaft 12 with the magnet 16 extending through the through hole 15 of the rotating member 14, so that the adhesive can be injected through the gap between the side surfaces of the magnet 16 and the through hole 15.

### Modification 2

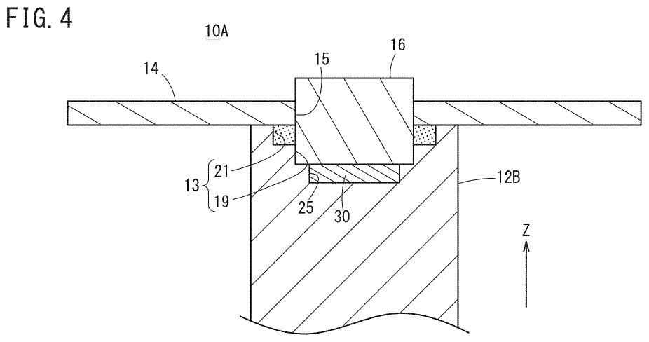

For example, as in an encoder 10A of Modification 2 shown in FIG. 4, a recess 25 having a smaller diameter than the reference hole 19 may be formed in the bottom of the recess 13 so as to place a nonmagnetic material 30 therein. That is, the nonmagnetic material 30 may be disposed so as to lie across the magnet 16 from the circuit board 18 (i.e., on the negative Z-direction side) in contact with the magnet 16. In this case, the influence of the shaft 12B, which is a magnetic material, on the magnetic field generated by the magnet 16 can be further reduced.

### Modification 3

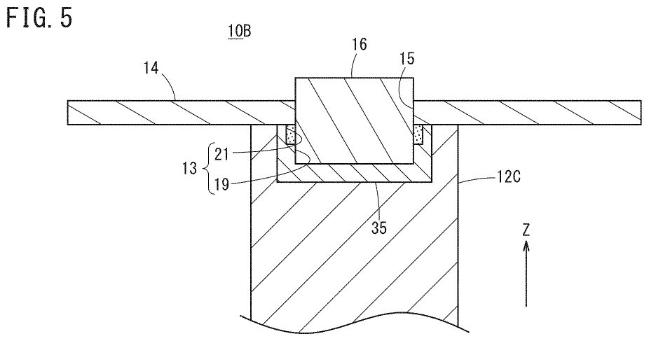

For example, as in an encoder 10B of Modification 3 shown in FIG. 5, an inner peripheral portion of the positive Z-direction side end of the shaft 12C may be made of a nonmagnetic material 35. The other portion of the shaft 12C other than the nonmagnetic material 35 is made of a magnetic material. The nonmagnetic material 35 has, formed therein, a recess 13 in which part of the magnet 16 protruding in the negative Z-direction from the through hole 15 is accommodated. In this case, the influence of the shaft 12C, which is made of a magnetic material, on the magnetic field generated by the magnet 16 can be markedly reduced. The recess 13 has a reference hole 19 for positioning the magnet 16 and an adhesive reservoir 21 having a greater diameter than the reference hole 19, formed on the opening side.

### Modification 4

As the magnet 16 rotates together with the shaft 12, the direction of the magnetic field of the magnet 16 changes, and the phase of the voltage signal output from the power generation element 20 changes accordingly. Therefore, in Modification 4 the output signal (voltage signal) from the power generation element 20 is sent to the signal processor 26, which detects the number of rotations of the shaft 12 based on the output signal from the power generation element 20. Detailedly, the phase change pattern of the output signal from the power generation element 20 during one rotation of the shaft 12 (the magnet 16) is stored in advance in a built-in memory of the signal processor 26. The signal processor 26 can detect the number of rotations of the shaft 12 by counting the number of repetitions of the phase change pattern.

### Modification 5

The configuration of the shafts 12, 12B and 12C for optically detecting the rotation angle, described in the above embodiment and Modifications, can be changed as appropriate. For example, instead of using the rotating member 14 having a light transmitting optical pattern with multiple light transmitting areas, a rotating member having a light reflecting optical pattern including multiple reflecting areas (mirror areas) may be used. In this case, the light emitter 22 is disposed on the negative Z-direction side surface of the circuit board 18, and the light emitted from the light emitter 22 and reflected by the reflecting areas of the optical pattern, is received by the light receiver 24 disposed on the negative Z-direction side surface of the circuit board 18.

### Modification 6

Though the rotation angle of the shafts 12, 12B and 12C is optically detected in the above-described embodiment and Modifications, the present invention is not limited to this. For example, the rotation angle of the shafts 12, 12B and 12C may be detected magnetically.

### Modification 7

Modifications 1 to 6 may be optionally combined as long as no technical inconsistency occurs.

[Inventions that can be Grasped from the Embodiment and Modifications 1 to 7]

According to the present invention, the encoder (10, 10A, 10B) includes: a shaft (12, 12B, 12C) configured to rotate together with an object to be measured; a rotating member (14) provided on one end side of the shaft (12, 12B, 12C) and having a pattern formed thereon to detect change of the rotation angle of the shaft (12, 12B, 12C); and a circuit board (18) arranged to face the rotating member (14) and configured to measure displacement of the rotating member (14). The encoder (10, 10A, 10B) further includes: a magnet (16) configured to rotate together with the shaft (12, 12B, 12C); and a power generation element (20) configured to generate electricity by rotation of the magnet (16). The magnet (16) is arranged so as to pass through a through hole (15) formed in the rotating member (14). The power generation element (20) is arranged on a surface of the circuit board (18) that is opposite to a surface thereof facing the rotating member (14).

With this configuration, the distance between the power generation element (20) and the magnet (16) can be shortened, and the distance between the rotating member (14) and the circuit board (18) can be shortened. As a result, the encoder (10) can be reduced in thickness.

A recess (13) may be formed on the one end side of the shaft (12, 12B, 12C) to accommodate the magnet (16) projecting from the rotating member (14) toward the shaft (12, 12B, 12C). This configuration makes it possible to firmly fix the magnet (16) to the shaft (12, 12B, 12C).

The recess (13) may have an adhesive reservoir (21) configured to retain an adhesive for joining the magnet (16) and the rotating member (14) to the shaft (12, 12B, 12C), and the magnet (16) and the rotating member (14) may be bonded to the shaft (12, 12B, 12C) by the adhesive retained in the adhesive reservoir (21). Owing thereto, it is possible to bond the magnet (16) and the rotating member (14) to the shaft (12, 12B, 12C) with the magnet (16) and the rotating member (14) abutted against the shaft.

The recess (13) may have a reference hole (19) configured to position the magnet (16), and an adhesive reservoir (21) having a diameter greater than the reference hole (19) and which is formed on the opening side of the recess, and the diameter of the through hole (15) may be smaller than that of the adhesive reservoir (21). This allows the magnet (16) to be easily positioned relative to the shaft (12, 12B, 12C), and also makes it possible to securely bond the magnet (16) and the rotating member (14) to the shaft (12, 12B, 12C).

The shaft (12, 12B) may be formed of a magnetic material. Owing thereto, the influence of the shaft (12, 12B) on the magnetic field generated by the magnet (16) can be reduced as compared with a case where the magnet (16) is embedded in the shaft (12, 12B).

A nonmagnetic material (30, 35) may be positioned across the magnet (16) from the circuit board (18) so as to be in contact with the magnet (16). This can reduce the influence of the shaft (12B, 12C) formed of a magnetic material on the magnetic field generated by the magnet (16).

The power generation element (20) and the magnet (16) may be disposed on the rotation axis of the shaft (12, 12B, 12C). This arrangement can improve the power generation efficiency of the power generation element (20).

The present invention is not particularly limited to the embodiment described above, and various modifications are possible without departing from the essence and gist of

What is claimed is:

1. An encoder comprising:
a shaft configured to rotate together with an object to be measured;
a rotating member provided on one end side of the shaft and having a pattern formed thereon to detect change of the rotation angle of the shaft;
a circuit board arranged to face the rotating member and configured to measure displacement of the rotating member;
a magnet configured to rotate together with the shaft; and
a power generation element configured to generate electricity by rotation of the magnet, wherein:
the magnet is arranged so as to pass through a through hole formed in the rotating member; and
the power generation element is arranged on a surface of the circuit board that is opposite to a surface thereof facing the rotating member.

2. The encoder according to claim 1, wherein a recess is formed on the one end side of the shaft to accommodate the magnet projecting from the rotating member toward the shaft.

3. The encoder according to claim 2, wherein:
the recess has an adhesive reservoir configured to retain an adhesive for joining the magnet and the rotating member to the shaft; and
the magnet and the rotating member are bonded to the shaft by the adhesive retained in the adhesive reservoir.

4. The encoder according to claim 2, wherein the recess has a reference hole configured to position the magnet, and an adhesive reservoir having a diameter greater than the reference hole and which is formed on an opening side of the recess; and
a diameter of the through hole is smaller than that of the adhesive reservoir.

5. The encoder according to claim 1, wherein the shaft is formed of a magnetic material.

6. The encoder according to claim 5, wherein a nonmagnetic material is positioned across the magnet from the circuit board so as to be in contact with the magnet.

7. The encoder according to claim 1, wherein the power generation element and the magnet are disposed on a rotation axis of the shaft.
